(19) United States
(12) Patent Application Publication
(10) Pub. No.: US 2013/0321368 A1
(43) Pub. Date: Dec. 5, 2013

(54) APPARATUS AND METHOD FOR PROVIDING IMAGE IN TERMINAL

(71) Applicant: Samsung Electronics Co., Ltd., Suwon-si (KR)

(72) Inventors: Chi-Hoon LEE, Seoul (KR); Ji-Young KANG, Suwon-si (KR); Mi-Jung PARK, Hwaseong-si (KR); Sae-Gee OH, Goyang-si (KR)

(73) Assignee: Samsung Electronics Co., Ltd., Suwon-si (KR)

(21) Appl. No.: 13/894,909

(22) Filed: May 15, 2013

(30) Foreign Application Priority Data
May 30, 2012 (KR) 10-2012--0057378

(51) Int. Cl. G09G 5/14

(52) U.S. Cl. CPC G09G 5/14
USPC 345/207

(57) ABSTRACT

An apparatus and a method for providing an image to allow a user to feel the perspective of images on a terminal depending on his or her gaze position and distance are provided. The apparatus includes a camera module for capturing a face image and a controller for displaying an image by rearranging a plurality of screen layers constituting the image depending on a change in positions of two eye images extracted from the face image captured by the camera module.

### PRIORITY

This application claims the benefit under 35 U.S.C. §119(a) of a Korean patent application filed on May 30, 2012 in the Korean Intellectual Property Office and assigned Serial No. 10-2012-0057378, the entire disclosure of which is hereby incorporated by reference.

### BACKGROUND OF THE INVENTION

1. Field of the Invention

The present invention relates to an apparatus and method for adjusting provision of images in a terminal. More particularly, the present invention relates to an image providing apparatus and method for allowing a user to feel the perspective of images on a terminal depending on his or her gaze position and distance.

2. Description of the Related Art

In recent years, 3-Dimensional (3D) image processing technologies have been used in various fields including education, training, health, movies, computer games, and the like. 3D image processing technologies are being used in such a diverse set of fields because 3D images may express better presence feeling, real feeling, and natural feeling, relative to 2-Dimensional (2D) images.

Many studies have been conducted to implement 3D image display devices. For implementation of the 3D image display devices, such devices require various technologies such as input technology, processing technology, transmission technology, display technology, software technology, and the like. In particular, studies on display technology, digital image processing technology, computer graphics technology, and human visual system are essential.

3D image display devices according to the related art may be classified into stereoscopic display devices and autostereoscopic display devices. The stereoscopic display devices may be subclassified into color separation-based display devices that allow users to view images with colored glasses, using different wavelengths of light; polarized glass-based display devices that use different vibration directions of light; and liquid crystal shutter-based display devices that allow users to view left-eye images and right-eye images separately in a time-division manner.

The autostereoscopic 3D display devices provide 3D stereoscopic images to users in a way of separately providing left-eye images and right-eye images so that the users may view the 3D stereoscopic images without wearing 3D glasses.

A 3D stereoscopic image providing technique according to the related art may provide vivid stereoscopic images to users by recognizing a change in view point upon detection of a change in position of user's head or face image, and rotating or rearranging the images displayed on a display depending on the user's gaze direction.

However, the rotating of displayed images simply depending on the user's gaze direction may not ensure the 3D effects that the user may feel the perspective of images as if he or she watches real-world scenes, as a far view and a near view differently respond to the user's gaze position.

Therefore, a need exists for an image providing apparatus and method for allowing a user to feel the perspective of images on a terminal depending on his or her gaze position and distance.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an image providing apparatus and method for allowing a user to feel the perspective of images on a terminal depending on his or her gaze position and distance.

In accordance with an aspect of the present invention, an apparatus for providing an image in a terminal is provided. The apparatus includes a camera module for capturing a face image; and a controller for displaying an image by rearranging a plurality of screen layers constituting the image depending on a change in positions of two eye images extracted from the face image captured by the camera module.

In accordance with another aspect of the present invention, a method for providing an image in a terminal is provided. The method includes extracting two eye images from a face image captured by a camera module; and displaying an image by rearranging a plurality of screen layers constituting the image depending on a change in positions of the extracted two eye images.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 shows a structure of a terminal according to an exemplary embodiment of the present invention.

FIGS. 2A and 2B show a process of providing images in a terminal according to an exemplary embodiment of the present invention.

FIGS. 3A and 3B show components for mapping eye images in a 3-Dimensional (3D) space in a process such as, for example, the process of FIGS. 2A and 2B, according to an exemplary embodiment of the present invention.

FIG. 4 shows a 3D space in which eye images are mapped in a process such as, for example, the process of FIGS. 2A and 2B, according to an exemplary embodiment of the present invention.

FIGS. 5A and 5B show positions of eye images which are shifted left/right and up/down in a 3D space, for example the 3D space of FIG. 4, according to an exemplary embodiment of the present invention.

FIG. 6 shows a plurality of screen layers in a process such as, for example, the process of FIGS. 2A and 2B, according to an exemplary embodiment of the present invention.

FIG. 7 shows an operation in which a plurality of screen layers constituting an image are rearranged in their associated reference positions in a process such as, for example, the process of FIGS. 2A and 2B, according to an exemplary embodiment of the present invention.

FIG. 8 shows an operation of displaying a perspective image by changing positions of a plurality of screen layers depending on a change in distance between a user's two eye images in a process such as, for example, the process of FIGS. 2A and 2B, according to an exemplary embodiment of the present invention.

FIG. 9 shows an image which is displayed on a terminal depending on shifts of a plurality of screen layers constituting the image, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention will now be described in detail with reference to accompanying drawings. Throughout the drawings, the same drawing reference numerals will be understood to refer to the same elements, features and structures.

Terminals, to which exemplary embodiments of the present invention are applicable, may include both mobile terminals and fixed terminals. The mobile terminals, which are mobile electronic devices that a user may easily carry, may include video phones, mobile phones, smart phones, International Mobile Telecommunication 2000 (IMT-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, Electronic [symbol] -Book, portable computers (e.g., notebook computers, tablet computers, and the like), digital cameras, and the like. The fixed terminals may include desktop computers, Personal Computers (PCs), and the like.

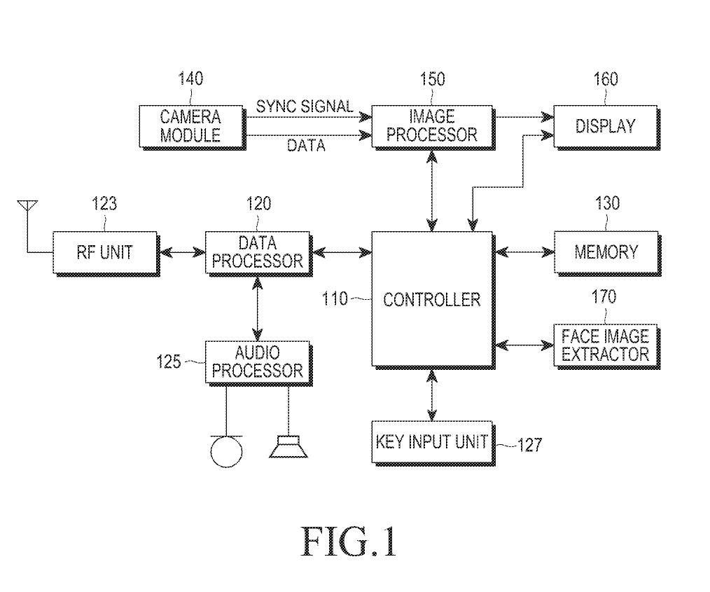

FIG. 1 shows a structure of a terminal according to an exemplary embodiment of the present invention.

Referring to FIG. 1, the terminal includes a controller 110, a data processor 120, a Radio Frequency (RF) unit 123, an audio processor 125, a key input unit 127, a memory 130, a camera module 140, an image processor 150, a display 160, and a face image extractor 170. The RF unit 123 is responsible for wireless communication of the terminal. The RF unit 123 includes an RF transmitter for up-converting a frequency of transmission signals and for amplifying the up-converted transmission signals, and an RF receiver for low-noise-amplifying received signals and for down-converting a frequency of the amplified received signals. A data processor 120 includes a transmitter for coding and modulating the transmission signals and a receiver for demodulating and decoding the received signals. In other words, the data processor 120 may include a modulator/demodulator (e.g., a modem) and a coder/decoder (e.g., a codec). The codec includes a data codec for processing data signals such as packet data, and an audio codec for processing audio signals such as voice. An audio processor 125 plays received audio signals output from the audio codec in the data processor 120, and transfers transmission audio signals picked up by a microphone to the audio codec in the data processor 120.

A key input unit 127 includes alphanumeric keys for inputting alphanumeric information and function keys for setting various functions of the terminal. As an example, the key input unit 127 may be a touch screen.

A memory 130 may include a program memory and a data memory. The program memory may store programs for controlling the overall operation of the terminal, and programs for displaying perspective images by rearranging a plurality of screen layers depending on the change in positions of user's eye images according to an exemplary embodiment of the present invention. The data memory may temporarily store the data generated during execution of the programs.

In accordance with an exemplary embodiment of the present invention, the memory 130 stores a plurality of images, and each image includes a plurality of screen layers, depths of which are differently set in order in advance. All or some of the plurality of screen layers may be configured to be transparent, such that when the plurality of screen layers overlap with each other, the screen layers may display a single image.

A controller 110 controls the overall operation of the terminal

In accordance with an exemplary embodiment of the present invention, the controller 110 may display a perspective image by rearranging a plurality of screen layers constituting one image depending on the change in positions of eye images extracted from a face image captured by a camera module 140.

The controller 110 may extract two eye images from a face image captured by the camera module 140, calculate and measure a distance between the extracted two eye images, and set the measured distance between two eye images as a reference distance E₀ between two eye images. According to an exemplary embodiment of the present invention, the controller 110 may calculate the distance between two eye images as corresponding to a distance between the center of one eye image and the center of the other eye image.

The controller 110 extracts, from the memory 130, a predetermined distance D₀ between a user and a screen of a display 160, which corresponds to the reference distance E₀ between two eye images.

Generally, the user starts viewing images at a proper distance corresponding to a distance at which the user can watch the screen of the display 160. In the image providing mode, the controller 110 may set a distance between positions (e.g., a distance between two eye images extracted through image capturing) of two initial eye images captured by the camera module 140, as a reference distance E₀ between two eye images. After setting the reference distance E₀ between two eye images through the initial image capturing, the controller 110 may extract its associated predetermined distance D₀ from the memory 130, estimating that the user is at a proper distance at which the user can watch the screen of the display 160.

According to exemplary embodiments of the present invention, in the image providing mode, the controller 110 may provide a predetermined reference distance E₀ between two eye images and its associated distance D₀ between a screen and a user, and the center of the reference distance E₀ between two eye images corresponds to the center of the screen of the display 160.

After setting the reference distance E₀ between two eye images, the controller 110 may extract two eye images from a face image captured by the camera module 140, and calculate and measure a distance Eₙ between the extracted two eye images. The controller 110 may compare the measured distance Eₙ between two eye images with the reference distance E₀ between two eye images, and extract components for mapping the two eye images, the distance Eₙ between which is measured, in a 3D space, if the measured distance Eₙ is different from the reference distance E₀.

As the components for mapping the two eye images in the 3D space, the controller 110 may extract a distance Dₙ between a screen and a user, which corresponds to the measured distance Eₙ between two eye images, and extract a left/right shift distance Wₙ and/or an up/down shift distance Hₙ from the center a₀ of the reference distance E₀ between two eye images to the center aₙ of the measured distance Eₙ between two eye images.

The controller 110 may calculate a difference between the measured distance Eₙ between two eye images and the reference distance E₀ between two eye images, and extract a distance Dₙ between a screen and a user by applying the difference to the distance D₀ between a screen and a user.

Otherwise, the controller 110 may calculate a difference between the measured distance Eₙ between two eye images and the reference distance E₀ between two eye images, and extract a distance value corresponding to the difference from the memory 130, as the distance Dₙ between a screen and a user.

After comparing the measured distance Eₙ between two eye images with the reference distance E₀ between two eye images, the controller 110 may display an image on the screen of the display 160 by rearranging a plurality of screen layers constituting the image in their predetermined reference positions, if the measured distance Eₙ is equal to the reference distance E₀.

Based on the components for mapping the two eye images in the 3D space, the controller 110 maps the two eye images, the distance Eₙ between which is measured, in the 3D space, and sets, as a center line Vₘ, a line connecting a virtual vanishing point V, which is set in a back of the screen in the 3D space, to the center a₀ of the reference distance E₀ between two eye images.

The controller 110 may measure a left/right shift distance and/or an up/down shift distance for each of the plurality of screen layers depending on the positions of eye images shifting with respect to the center line Vₘ in accordance with Equation (1) below.

$$Left / RightShiftDistanceForLayerN = \frac{( DepthV - DepthN )}{( DepthV - {D}_{n} )} * {W}_{n} \\ Up / DownShiftDistanceForLayerN = \frac{( DepthV - DepthN )}{( DepthV - {D}_{n )}} * {H}_{n} \qquad ( 1 )$$

where n>1, Depth V corresponds to a predetermined distance between the virtual vanishing point V and a screen of a display, Depth N corresponds to a predetermined distance between an N-th screen layer among the plurality of screen layers and the screen of the display; Dₙ corresponds to a distance between the screen of the display and the user, which corresponds to the measured distance Eₙ between two eye images, Wₙ corresponds to a left/right shift distance from the center a₀ of the reference distance E₀ between two eye images to the center aₙ of the measured distance Eₙ between two eye images, and Hₙ corresponds to an up/down shift distance from the center a₀ of the reference distance E₀ between two eye images to the center aₙ of the measured distance Eₙ between two eye images.

The controller 110 may display a perspective image by rearranging the plurality of screen layers, the left/right shift distance and the up/down shift distance of which are measured, depending on the positions of eye images shifting with respect to the center line Vₘ.

A face image extractor 170 may extract a user's face image from an object captured by the camera module 140, extract eye images from the extracted face image, and provide the extracted images to the controller 110.

The camera module 140 includes a camera sensor for capturing image data and for converting the captured optical image signal into an electrical image signal, and a signal processor for converting analog image signals captured by the camera sensor into digital image data. The camera sensor is assumed to be a Charge Coupled Device (CCD) sensor or a Complementary Metal-Oxide Semiconductor (CMOS) sensor, and the signal processor may be implemented with a Digital Signal Processor (DSP). The camera sensor and the signal processor may be implemented integrally or separately.

When providing images on the screen of the display 160, the camera module 140 may operate automatically or manually.

An image processor 150 performs Image Signal Processing (ISP) to display image signals output from the camera module 140 on the display 160. The ISP may include gamma correction, interpolation, spatial variation, image effecting, image scaling, Auto White Balance (AWB), Auto Exposure (AE), Auto Focus (AF), and the like. The image processor 150 processes the image signals output from the camera module 140 on a frame basis, and outputs the frame image data to well-match with the characteristics and size of the display 160. The image processor 150 includes a video codec and may compress frame image data displayed on the display 160 by predetermined coding, and decompress compressed frame image data into its original frame image data. The video codec may be any one of a Joint Photographic Experts Group (JPEG) codec, a Moving Picture Experts Group-4 (MPEG4) codec, a Wavelet codec, and the like. The image processor 150 is assumed to have an On Screen Display (OSD) feature, and may output OSD data depending on the size of the displayed screen, under control of the controller 110.

The display 160 displays, on a screen, image signals output from the image processor 150 and user data output from the controller 110. The display 160 may include a Liquid Crystal Display (LCD), and the like. In the case in which the display includes an LCD, the display 160 may include an LCD controller, a memory for storing image data, and an LCD panel. When the LCD is implemented to support a touch screen feature, the display 160 may serve as an input unit, and in this case, the same keys as those on the key input unit 127 may be displayed on the display 160.

In accordance with an exemplary embodiment of the present invention, the display 160 may display perspective images depending on the change in positions of user's eye images captured by the camera module 140.

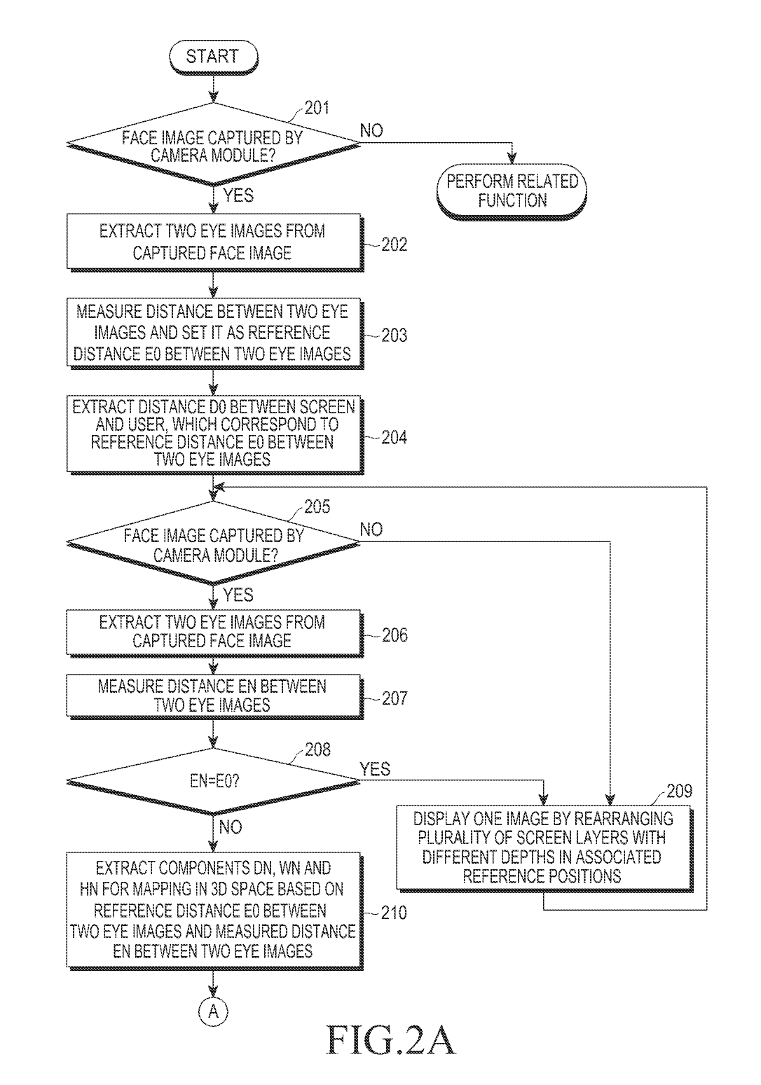

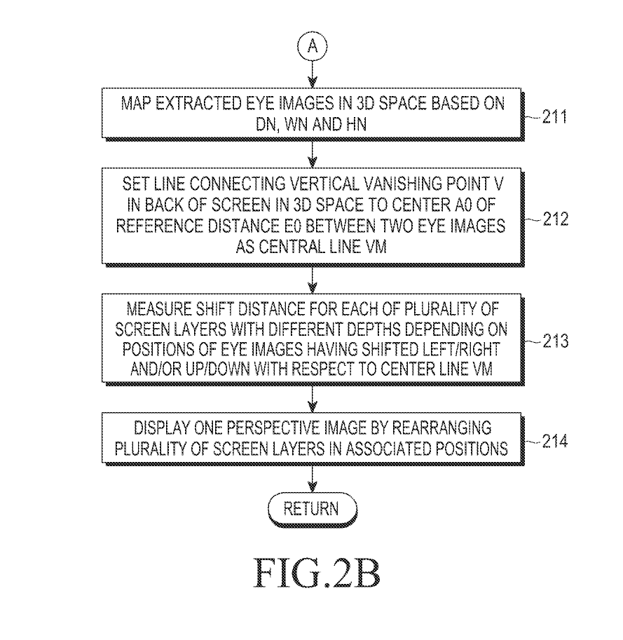

An operation of displaying perspective images depending on the change in positions of user's eye images in the above-described terminal will be described in detail with reference to FIGS. 2A to 9.

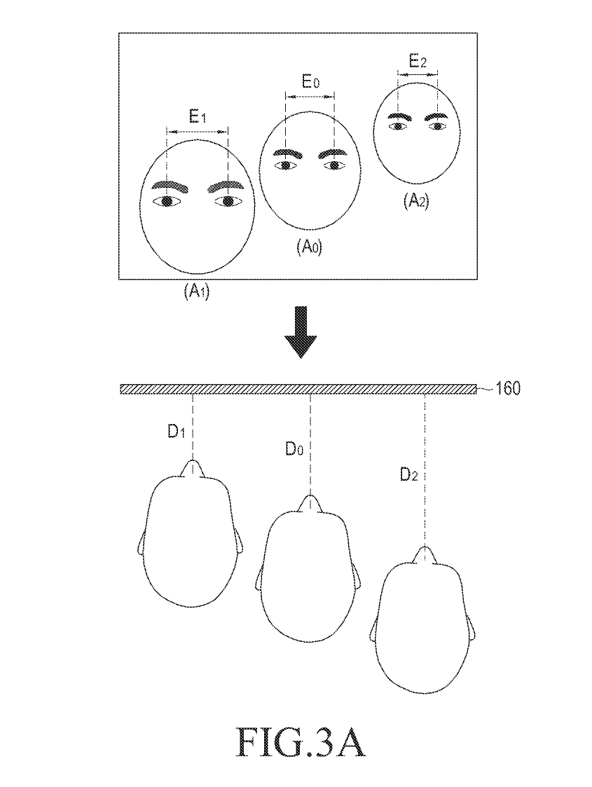

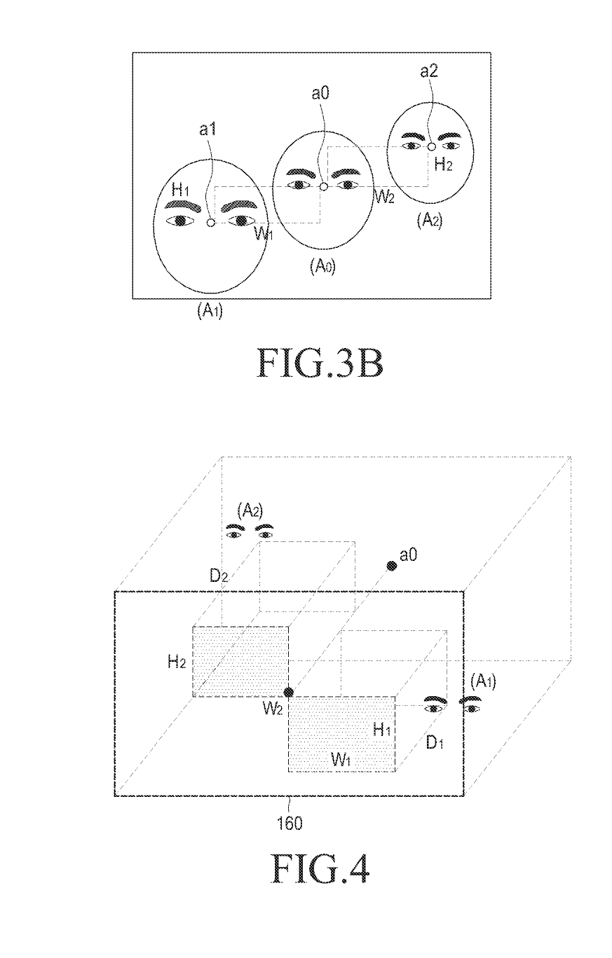

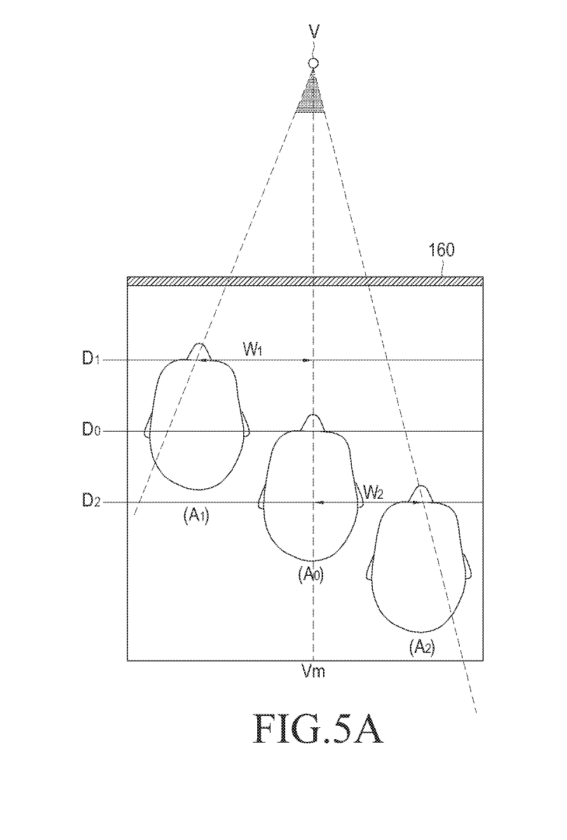

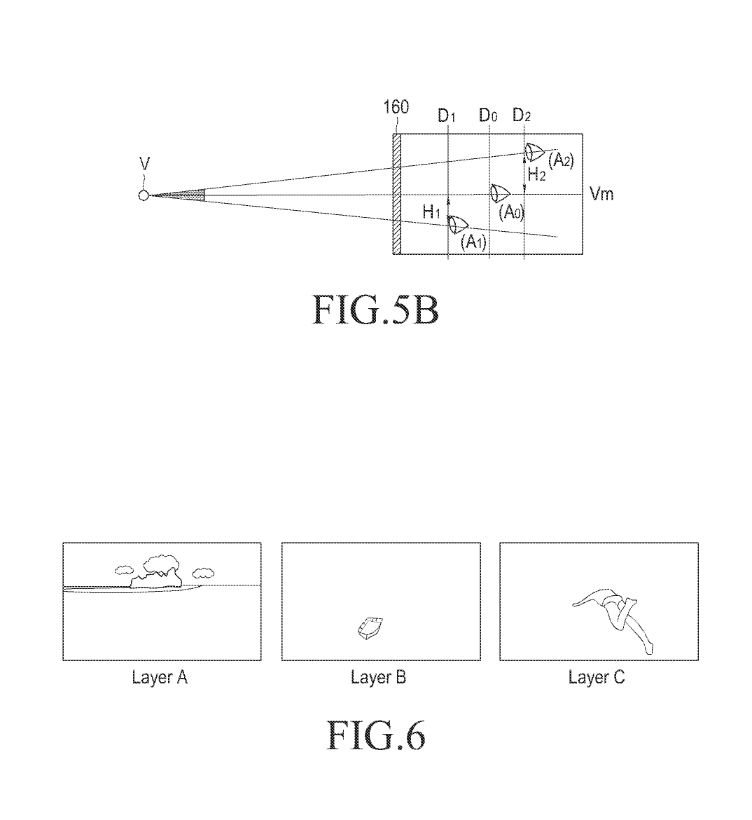

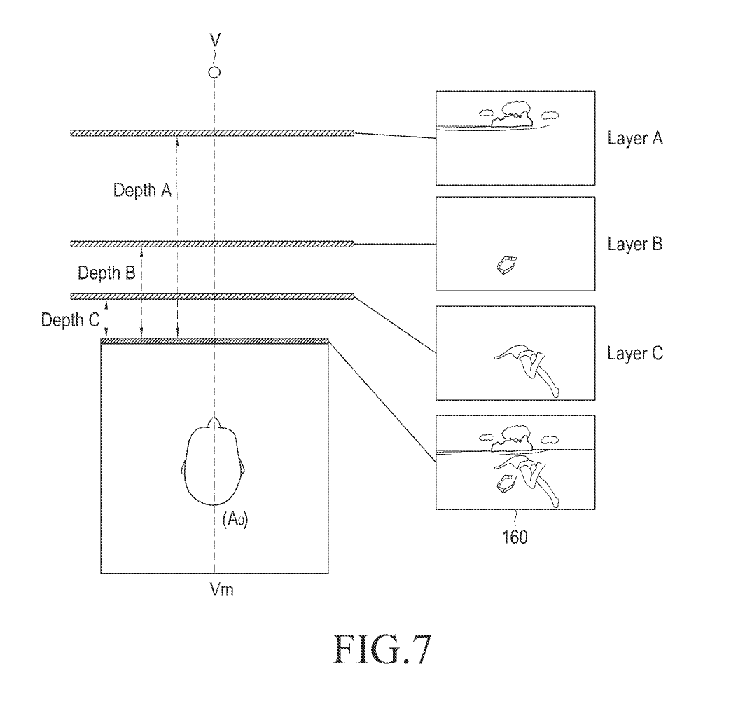

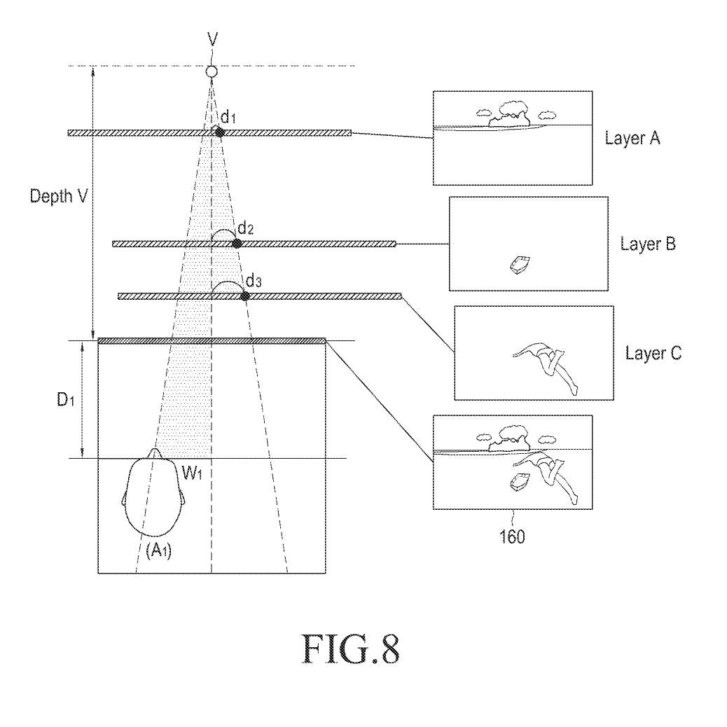

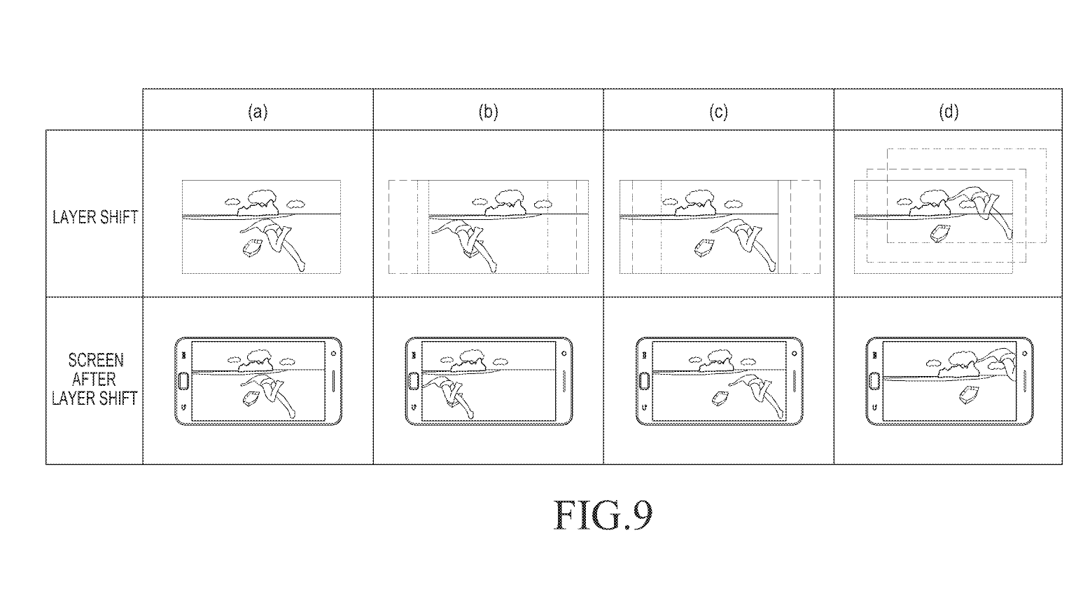

FIGS. 2A and 2B show a process of providing images in a terminal according to an exemplary embodiment of the present invention. FIGS. 3A and 3B show components for mapping eye images in a 3-Dimensional (3D) space in a process such as, for example, the process of FIGS. 2A and 2B. FIG. 4 shows a 3D space in which eye images are mapped in a process such as, for example, the process of FIGS. 2A and 2B according to an exemplary embodiment of the present invention. FIGS. 5A and 5B show positions of eye images which are shifted left/right and up/down in a 3D space such as, for example, the 3D space of FIG. 4 according to an exemplary embodiment of the present invention. FIG. 6 shows a plurality of screen layers in a process such as, for example, the process of FIGS. 2A and 2B according to an exemplary embodiment of the present invention. FIG. 7 shows an operation in which a plurality of screen layers constituting an image are rearranged in their associated reference positions in a process such as, for example, the process of FIGS. 2A and 2B according to an exemplary embodiment of the present invention. FIG. 8 shows an operation of displaying a perspective image by changing positions of a plurality of screen layers depending on a change in distance between a user's two eye images in a process such as, for example, the process of FIGS. 2A and 2B according to an exemplary embodiment of the present invention. FIG. 9 shows an image which is displayed on a terminal depending on shifts of a plurality of screen layers constituting the image, according to an exemplary embodiment of the present invention.

Exemplary embodiments of the present invention will be described in detail below with reference to FIGS. 2A to 9, together with FIG. 1.

Referring to FIGS. 2A and 2B, in step 201, the terminal determines whether a user's face is captured by a camera module 140. If a user's face is not captured by the camera module 140 in step 201, then the terminal proceeds to perform a related function. If a user's face image captured by the camera module 140 in the image providing mode in step 201, then the terminal proceeds to step 202 and the controller 110 provides the captured face image to the face image extractor 170. In step 202, the face image extractor 170 extracts two eye images from the captured face image and provides the extracted eye images to the controller 110. Thereafter, the terminal proceeds to step 203 in which the controller 110 measures a distance between the extracted two eye images and sets the initially measured distance between two eye images as a reference distance E₀ between two eye images.

In step 204, the controller 110 extracts a distance D₀ between a user and a screen of a display 160, which corresponds to the reference distance E₀ between two eye images, from the memory 130.

Generally, the user starts viewing images at a proper distance at which the user is able to watch the screen of the display 160. According to exemplary embodiments of the present invention, in the image providing mode, the controller 110 may set a distance between positions (e.g., a distance between two eye images extracted through image capturing) of two initial eye images captured by the camera module 140, as a reference distance E₀ between two eye images. After setting the reference distance E₀ between two eye images through the initial image capturing, the controller 110 may extract its associated predetermined distance D₀ from the memory 130, estimating that the user is at a proper distance at which the user is able to watch the screen of the display 160.

In the image providing mode, the controller 110 may provide a predetermined reference distance E₀ between two eye images and its associated distance D₀ between a screen and a user, and the center of the reference distance E₀ between two eye images corresponds to the center of the screen of the display 160.

After extracting the reference distance E₀ between two eye images, the terminal proceeds to step 205 in which the controller 110 determines whether a user's face image is captured by the camera module 140.

After extracting the reference distance E₀ between two eye images, if a user's face image is not captured by the camera module 140 in step 205, then the controller 110 displays in step 209 an image on the screen of the display 160 by rearranging a plurality of screen layers, depths of which are differently set in order in advance, in their associated reference positions.

The image displayed in step 209 may be a displayable reference image when the distance D₀ between a screen and a user corresponds to the reference distance E₀ between two eye images.

If a user's face image is captured by the camera module 140 in step 205, then the controller 110 provides the captured face image to the face image extractor 170 and the terminal proceeds to step 206. In step 206, the face image extractor 170 extracts two eye images from the captured face image and provides the extracted eye images to the controller 110 and the terminal proceeds to step 207. In step 207, the controller 110 calculates and measures a distance Eₙ between the extracted two eye images.

In step 208, the controller 110 compares the distance Eₙ between the extracted two eye images, which is measured in step 207, with the reference distance E₀ between two eye images, which is set in step 203, to determine whether the distances are equal to each other. If the distances are equal to each other, then the controller 110 proceeds to step 209.

However, if the distances are determined to not equal to each other in step 208, then the terminal proceeds to step 210 in which the controller 110 extracts components for mapping the two eye images, the distance Eₙ between which is measured in step 207, in the 3D space, based on the distance Eₙ between the extracted two eye images, which is measured in step 207, and the reference distance E₀ between two eye images, which is set in step 203.

In step 210, as the components for mapping the two eye images in the 3D space, the controller 110 extracts a distance Dₙ between a screen and a user, which corresponds to the measured distance Eₙ between two eye images, and extracts a left/right shift distance Wₙ and/or an up/down shift distance Hₙ from the center a₀ of the reference distance E₀ between two eye images to the center aₙ of the measured distance Eₙ between two eye images.

To extract a distance Dₙ between a screen and a user, which corresponds to the measured distance Eₙ between two eye images, the controller 110 may calculate a difference between the measured distance Eₙ between two eye images and the reference distance E₀ between two eye images, and extract the distance Dₙ between a screen and a user by applying the difference to the distance D₀ between a screen of the display 160 and a user. Otherwise, the controller 110 may calculate a difference between the measured distance Eₙ between two eye images and the reference distance E₀ between two eye images, and extract a distance value corresponding to the difference from the memory 130, as the distance Dₙ between a screen and a user.

The above processes will be described with reference to FIGS. 3A and 3B. FIG. 3A shows distances from a screen to a user, which are based on distances between a user's two eye images.

Referring to FIG. 3A, a distance between two eye images extracted from a face image captured at a user's face position A₀ is set as a reference distance E₀ between two eye images, and a distance D₀ between a screen of the display 160 and a user, which corresponds to the reference distance E₀ between two eye images, is extracted from the memory 130.

After the reference distance E₀ between two eye images is set, a distance E₁ between two eye images extracted from a face image captured at a user's face position A₁ having shifted left and down from the user's face position A₀ is measured, and a distance D₁ between a screen of the display 160 and a user, which corresponds to the distance E₁ between two eye images, is measured. It can be understood that the user's face position A₁ is closer to the screen than the user's face position A₀, because the distance D₁ between a screen of the display 160 and a user is shorter than the distance D₀ between a screen of the display 160 and a user.

Otherwise, after the reference distance E₀ between two eye images is set, a distance E2 between two eye images extracted from a face image captured at a user's face position A₂ having shifted right and up from the user's face position A₀ is measured, and a distance D₂ between a screen of the display 160 and a user, which corresponds to the distance E2 between two eye images, is measured. It can be understood that the user's face position A₂ is farther away from the screen than the user's face position A₀, because the distance D₂ between a screen of the display 160 and a user is longer than the distance D₀ between a screen of the display 160 and a user.

Referring to FIG. 3B, a left shift distance W₁ and a down shift distance H₁ from the center a₀ of the reference distance E₀ between two eye images, which is set at the user's face position A₀, to the center a₁ of the distance E₁ between two eye images, which is measured at the user's face position A₁, are measured. In addition, a right shift distance W₂ and an up shift distance H₂ from the center a₀ of the reference distance E₀ between two eye images, which is set at the user's face position A₀, to the center a₂ of the distance E2 between two eye images, which is measured at the user's face position A₂, are measured.

After extracting the components Dₘ Wₙ, and Hₙ for mapping the two eye images in the 3D space in step 210, the terminal proceeds to step 211 in which the controller 110 maps the two eye images, the distance Eₙ between which is measured in step 207, in the 3D space based on the components Dₙ, Wₘ and Hₙ. The terminal then proceeds to step 212.

In step 212, the controller 110 sets a virtual vanishing point V in a back of a screen in the 3D space where the eye images are mapped in step 211, and sets a line connecting the virtual vanishing point V to the center a₀ of the reference distance between two eye images, as a center line Vₘ.

Steps 211 and 212 will be described with reference to FIGS. 4, 5A and 5B. It is shown in FIG. 4 that two eye images in the user's face position A₁ are mapped in the 3D space based on the components D₁, W₁ and H₁ for mapping in the 3D space, which are extracted in connection with FIGS. 3A and 3B, and two eye images in the user's face position A₂ are mapped in the 3D space based on the components D₂, W₂ and H₂ for mapping in the 3D space, which are extracted in connection with FIGS. 3A and 3B.

FIG. 5A is a view seen from the top of the 3D space in which the user's two eye images are mapped depending on user's face positions A₁ and A₂ as in FIG. 4, showing eye images in the user's face positions A₁ and A₂ which have shifted left and right (along the x-axis) from the eye images in the user's face position A₀.

FIG. 5B is a view seen from the side of the 3D space in which a user's two eye images are mapped depending on user's face positions A₁ and A₂ as in FIG. 4, showing eye images in the user's face positions A₁ and A₂ which have shifted up and down (along the y-axis) from the eye images in the user's face position A₀.

In FIGS. 5A and 5B, a virtual vanishing point V is set in a back of the screen in the 3D space, a line connecting the virtual vanishing point V to the center a₀ of the reference distance E₀ between two eye images is set as a center line Vₘ, and user's eye images are shown, which are shifted left/right and/or up/down with respect to the center line Vₘ depending on user's face positions A₁ and A₂.

After setting the center line Vₘ in step 212, the controller 110 measures, in step 213, a shift distance in accordance with Equation (1), for each of the plurality of screen layers, depths of which are differently set in order in advance, depending on positions of eye images which have shifted left/right and/or up/down with respect to the center line Vₘ.

After measuring the left/right shift distance and/or the up/down shift distance for each of the plurality of screen layers in accordance with Equation (1), the controller 110 displays, in step 214, an image including a plurality of screen layers in a perspective way depending on the user's gaze position, by rearranging the plurality of screen layers in their associated positions after shifting them by the measured shift distances.

Steps 213 and 214 will be described with reference to FIGS. 6 to 8. FIG. 6 shows a plurality of screen layers Layer A, Layer B, and Layer C constituting one image.

For the plurality of screen layers in FIG. 6, their depths are differently set in order as shown in FIG. 7. For example, in the z-axis direction, the Layer A is set in advance to have a depth A, the Layer B is set in advance to have a depth B, and the Layer C is set in advance to have a depth C.

FIG. 7 shows a reference image which may be displayed on a screen of the display 160 when the distance D₀ between a screen of the display 160 and a user corresponds to the reference distance E₀ between two eye images, as in step 209.

While the reference image is displayed in the user's face position A₀ as shown in FIG. 7, if the user's face image shifts from the user's face position A₀ to the user's face position A₁ as it shifts to the left and down sides, a right shift distance and an up shift distance are measured for each of the plurality of screen layers Layer A, Layer B and Layer C in accordance with Equation (1).

In FIG. 8 showing the 3D space as seen from the top, the plurality of screen layers Layer A, Layer B and Layer C are shifted to the right by their associated right shift distances d₁ to d₃ measured in accordance with Equation (1). Although not shown, the plurality of screen layers Layer A, Layer B and Layer C are shifted to the up side by their associated up shift distances measured in accordance with Equation (1). As a result, one image including a plurality of rearranged screen layers may be displayed on the screen of the display 160, as shown in FIG. 8.

As shown in FIG. 8, when a user's face image shifts from the user's face position A₀ to the user's face position A₁, the plurality of screen layers shift in the opposite direction, making it possible to provide perspective images to the user depending on the user's gaze direction and distance.

FIG. 9 shows an image which is displayed on a screen of the display 160 depending on shifts of a plurality of screen layers constituting the image.

In FIG. 9, (a) shows a reference image displayed in the user's face position A₀ as in FIG. 7, and (b) shows an image that is displayed after its plurality of screen layers are shifted left when the user's face image shifts to the right in (a) of FIG. 9.

In FIG. 9, (c) shows an image that is displayed after its plurality of screen layers are shifted right when the user's face image shifts to the left in (a) of FIG. 9, and (d) shows an image that is displayed after its plurality of screen layers are shifted to the right and up sides when the user's face image shifts to the left and down sides in (a) of FIG. 9.

According to exemplary embodiments of the present invention, the apparatus and method for providing images in a terminal may be implemented in a non-transient computer-readable recording medium as computer-readable codes. The non-transient computer-readable recording medium may include any kind of recording devices in which data readable by a computer system is stored. Examples of the recording medium may include Read Only Memory (ROM), Random Access Memory (RAM), optical disk, magnetic tape, floppy disk, hard disk, non-volatile memory, etc., and may also include being implemented in the form of a carrier wave (e.g., transmission over the Internet). In the non-transient computer-readable recording medium, computer-readable codes may be stored and executed in a distributed manner in which they are distributed over computer systems connected to the network.

As is apparent from the foregoing description, according to exemplary embodiments of the present invention, the apparatus and method for providing images in a terminal may provide an image in which a far view has a less shift and a near view has a greater shift depending on the user's gaze position, making it possible to provide perspective images to users.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing an image in a terminal, the apparatus comprising:
a camera module for capturing a face image; and
a controller for displaying an image by rearranging a plurality of screen layers constituting the image depending on a change in positions of two eye images extracted from the face image captured by the camera module.

2. The apparatus of claim 1, further comprising:
a face image extractor for extracting a face image from an object captured by the camera module, for extracting two eye images from the face image, and for providing the extracted images to the controller; and
a memory for storing an image including a plurality of screen layers, depths of which are differently set in order.

3. The apparatus of claim 1, wherein the controller measures a distance between two eye images extracted from the face image captured by the camera module, sets the measured distance between two eye images as a reference distance E₀ between two eye images, and extracts a distance D₀ between a screen and a user, which is set in advance for the reference distance E₀ between two eye images.

4. The apparatus of claim 3, wherein after setting the reference distance E₀ between two eye images, the controller measures a distance Eₙ between two eye images in the face image captured by the camera module, compares the measured distance Eₙ between two eye images with the reference distance E₀ between two eye images, and extracts components for mapping the two eye images, the distance Eₙ between which is measured, in a 3-Dimensional (3D) space, if the measured distance Eₙ is different from the reference distance E₀.

5. The apparatus of claim 4, wherein the components for mapping the two eye images in a 3D space includes a distance Dₙ between a screen and a user, which corresponds to the measured distance Eₙ between two eye images, and a left/right shift distance Wₙ and an up/down shift distance Hₙ from a center a₀ of the reference distance E₀ between two eye images to a center aₙ of the measured distance Eₙ between two eye images.

6. The apparatus of claim 5, wherein the controller extracts the distance Dₙ between a screen and a user, which corresponds to the measured distance Eₙ between two eye images, depending on a difference between the measured distance Eₙ between two eye images and the reference distance E₀ between two eye images.

7. The apparatus of claim 4, wherein the controller displays an image by rearranging the plurality of screen layers in associated reference positions if the measured distance Eₙ is equal to the reference distance E₀.

8. The apparatus of claim 4, wherein the controller maps the two eye images, between which the distance Eₙ is measured, in the 3D space based on the components for mapping the two eye images in a 3D space.

9. The apparatus of claim 8, wherein when the two eye images are mapped in the 3D space, the controller sets, as a center line Vₘ, a line connecting a virtual vanishing point V, which is set in a back of a screen in the 3D space, to a center a₀ of the reference distance E₀ between two eye images.

10. The apparatus of claim 9, wherein the controller measures a left/right shift distance and an up/down shift distance for each of the plurality of screen layers depending on positions of two eye images shifting with respect to the center line Vₘ, in accordance with the following equation:
$$Left / RightShiftDistanceForLayerN = \frac{( DepthV - DepthN )}{( DepthV - {D}_{n} )} * {W}_{n}$$
$$Up / DownShiftDistanceForLayerN = \frac{( DepthV - DepthN )}{( DepthV - {D}_{n )}} * {H}_{n}$$
where n>1, Depth V corresponds to a predetermined distance between the virtual vanishing point V and a screen of a display, Depth N corresponds to a predetermined distance between an N-th screen layer among the plurality of screen layers and the screen of the display, Dₙ corresponds to a distance between the screen of the display and the user, which corresponds to the measured distance Eₙ between two eye images, Wₙ corresponds to a left/right shift distance from the center a₀ of the reference distance E₀ between two eye images to the center aₙ of the measured distance Eₙ between two eye images, and Hₙ corresponds to an up/down shift distance from the center a₀ of the reference distance E₀ between two eye images to the center aₙ of the measured distance Eₙ between two eye images.

11. The apparatus of claim 10, wherein the controller displays an image by rearranging the plurality of screen layers, the left/right shift distance and the up/down shift distance of which are measured, in associated positions depending on positions of two eye images shifting with respect to the center line Vₘ.

12. A method for providing an image in a terminal, the method comprising:
extracting two eye images from a face image captured by a camera module; and
displaying an image by rearranging a plurality of screen layers constituting the image depending on a change in positions of the extracted two eye images.

13. The method of claim 12, wherein the displaying of the image comprises:
extracting a reference distance E₀ between two eye images;
extracting a distance D₀ between a screen and a user, which is set in advance for the reference distance E₀ between two eye images;
comparing the reference distance E₀ between two eye images with a distance Eₙ between two eye images, which is measured in the face image captured by the camera module;
extracting components for mapping the two eye images, the distance Eₙ between which is measured, in a 3-Dimensional (3D) space, if the measured distance Eₙ is different from the reference distance E₀;
mapping the two eye images, between which the distance Eₙ is measured, in the 3D space based on the components for mapping the two eye images in the 3D space;
measuring a shift distance for each of the plurality of screen layers depending on positions of the two eye images mapped in the 3D space; and
displaying the image by rearranging the plurality of screen layers, shift distances of which are measured, in associated positions.

14. The method of claim 13, wherein the extracting of the distance D₀ comprises:
measuring a distance between two eye images extracted from the face image captured by the camera module;
setting the measured distance between two eye images as the reference distance E₀ between two eye images; and
extracting the distance D₀ between the screen and the user, which is set in advance for the reference distance E₀ between two eye images.

15. The method of claim 13, wherein the extracting of the components for mapping the two eye images comprises:
extracting a distance Dₙ between the screen and the user, which corresponds to the measured distance Eₙ between two eye images; and
extracting a left/right shift distance Wₙ and an up/down shift distance Hₙ from a center a₀ of the reference distance E₀ between two eye images to a center aₙ of the measured distance Eₙ between two eye images.

16. The method of claim 15, wherein the extracting of the distance Dₙ comprises extracting the distance Dₙ between the screen and the user, which corresponds to the measured distance Eₙ between two eye images, depending on a difference between the measured distance Eₙ between two eye images and the reference distance E₀ between two eye images.

17. The method of claim 13, further comprising displaying the image by rearranging the plurality of screen layers in associated reference positions if the measured distance Eₙ is equal to the reference distance E₀.

18. The method of claim 13, wherein the measuring of the shift distance for each of the plurality of screen layers comprises:
setting a virtual vanishing point V in a back of the screen in the 3D space, when the two eye images are mapped in the 3D space;
setting, as a center line Vₘ, a line connecting the virtual vanishing point V to a center a₀ of the reference distance E₀ between two eye images; and
measuring a left/right shift distance and an up/down shift distance for each of the plurality of screen layers depending on positions of two eye images shifting with respect to the center line Vₘ.

19. The method of claim 18, wherein the measuring of the left/right shift distance and the an up/down shift distance for each of the plurality of screen layers is achieved in accordance with the following equation;
$$Left / RightShiftDistanceForLayerN = \frac{( DepthV - DepthN )}{( DepthV - {D}_{n} )} * {W}_{n}$$
$$Up / DownShiftDistanceForLayerN = \frac{( DepthV - DepthN )}{( DepthV - {D}_{n )}} * {H}_{n}$$
where n>1, Depth V corresponds to a predetermined distance between the virtual vanishing point V and a screen of a display, Depth N corresponds to a predetermined distance between an N-th screen layer among the plurality of screen layers and the screen of the display, Dₙ corresponds to a distance between the screen of the display and the user, which corresponds to the measured distance Eₙ between two eye images, Wₙ corresponds to a left/right shift distance from the center a₀ of the reference distance E₀ between two eye images to the center aₙ of the measured distance Eₙ between two eye images, and Hₙ corresponds to an up/down shift distance from the center a₀ of the reference distance E₀ between two eye images to the center aₙ of the measured distance Eₙ between two eye images.

20. The method of claim 13, wherein the displaying of the image comprises displaying the image by rearranging the plurality of screen layers, the left/right shift distance and the up/down shift distance of which are measured, in associated positions.

21. The method of claim 12, wherein depths of the plurality of screen layers constituting the image are differently set in order in advance.

22. A non-transient processor-readable recording medium recording a program for performing the method as set forth in claim 12.
